(19) United States
(12) Patent Application Publication
(10) Pub. No.: US 2011/0227000 A1
(43) Pub. Date: Sep. 22, 2011

(54) ELECTROPHORETIC DEPOSITION AND REDUCTION OF GRAPHENE OXIDE TO MAKE GRAPHENE FILM COATINGS AND ELECTRODE STRUCTURES

(76) Inventors: Rodney S. Ruoff, Austin, TX (US); Sung Jin An, Gumi-si (KR); Meryl Stoller, Austin, TX (US); Tryggvi Emilsson, Champaign, IL (US); Dileep Agnihotri, Round Rock, TX (US)

(21) Appl. No.: 13/052,713

(22) Filed: Mar. 21, 2011

Related U.S. Application Data
(60) Provisional application No. 61/315,473, filed on Mar. 19, 2010.

(51) Int. Cl. C01B 31/00; H01B 1/04; C25D 13/02; B82Y 30/00

(52) U.S. Cl. 252/502; 423/415.1; 204/490; 204/477; 977/734; 977/773; 977/762

(57) ABSTRACT

Disclosed are methods for preparing electrophoretically deposited graphene based films.

### CROSS-REFERENCE TO RELATED APPLICATIONS

This application claims priority to U.S. Provisional Application Ser. No. 61/315,473, filed on Mar. 19, 2010, which is hereby incorporated by reference.

### STATEMENT OF GOVERNMENT SUPPORT

This invention was made with government support under Grant No. DE-SC001951, awarded by the Department of Energy. The United States government has certain rights in the invention.

### FIELD OF THE INVENTION

This disclosure relates to graphene materials, and specifically to methods for the preparation of graphene based films.

### BACKGROUND

Graphene materials have been the subject of considerable research, at least in part due to their electrical, mechanical, and thermal properties, and their potential use as transparent conductive film, in composite materials, and other applications. Graphene oxide (G-O) that has been chemically or thermally reduced (RG-O) has been used in the fabrication of field effect transistors (FETs), single-molecule gas detectors, ultracapacitors, solar cells, liquid crystal devices, transparent conducting films, polymer composites, and other devices. Solution-based deposition methods, including membrane filtration, dip coating, layer-by-layer (LbL), spray-coating, and spin coating have been used to prepare thin graphene-based films. These preparation methods can have undesirable limitations. For example, the size of films produced from a membrane filtration method can be limited to the size of the membrane, rendering the method ineffective for producing large area materials. Similarly, other techniques can be more amenable to large area production, but with poor control of film thickness and/or uniformity.

Thus, a need exists for methods to prepare films, such as, for example, large area graphene-based films. These needs and other needs are at least partially satisfied by the present invention.

### SUMMARY

In accordance with the purpose(s) of the invention, as embodied and broadly described herein, the invention, in one aspect, relates to graphene materials, and specifically to methods for the preparation of graphene based films.

In one aspect, the present disclosure provides a method for depositing a graphene material on a substrate, the method comprising providing a suspension of graphene oxide platelets and a substrate, and then applying an electric field across at least a portion of the suspension so as to deposit at least a portion of the graphene oxide platelets on the substrate.

In another aspect, the present disclosure provides a method for depositing a graphene material on a substrate using an electrophoretic technique.

In another aspect, the present disclosure provides a method for depositing a graphene material on a substrate, wherein graphene oxide platelets are simultaneously deposited on a substrate and reduced.

In another aspect, the present disclosure provides an electrode comprising a reduced graphene oxide film prepared from an electrophoretic deposition technique.

In yet another aspect, the present disclosure provides a composition comprising a matrix of electrically conductive reduced graphene oxide and a plurality of nanoparticles, wires, or a combination thereof embedded therein.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 is: (a) a schematic illustration of an electrophoretic deposition process, and (b) a cross-sectional scanning electron micrograph of an electrophoretically deposited graphene oxide film, in accordance with various aspects of the present invention.

FIG. 2 illustrates cross-sectional field emission scanning electron micrographs of an electrophoretically deposited G-O film with varying deposition times: (a) 30 sec, (b) 2 min, (c) 4 min, and (d) 10 min.

FIG. 3 illustrates Raman spectra of a G-O film prepared by filtration (top line) and electrophoretic deposition (bottom line).

FIG. 4 illustrates x-ray diffraction patterns for (a) an air dried electrophoretically deposited G-O film, and (b) the same film after annealing at 100° C.

FIG. 5 illustrates x-ray photoelectron spectra of G-O paper prepared by filtration (top line), electrophoretic deposition (second line from top), electrophoretic deposition after annealing at 100° C. (third line from top), and chemically reduced graphene oxide (CReGO) (bottom line).

FIG. 6 illustrates the weight loss profile of an air-dried electrophoretically deposited G-O film, as determined by thermogravimetric analysis.

FIG. 7 illustrates Fourier transform infrared spectra of G-O paper prepared by filtration (bottom line) and electrophoretic deposition (top line).

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated by reference to disclose and describe the methods and/or materials in connection with which the publications are cited.

As used in the specification and the appended claims, the singular forms “a,” “an” and “the” include plural referents unless the context clearly dictates otherwise. Thus, for example, reference to “an electrode” includes mixtures of two or more such electrodes.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

It should be noted that any directions, such as, for example, top, bottom, and side, are only intended to represent a relative position to other components and are not intended to specify a particular orientation of a device or component. It should also be noted that any device or component to which a direction is referenced can be adjusted and/or modified such that the specific direction can change.

As used herein, the term “G-O” is intended to refer to graphene oxide, unless specifically stated to the contrary. As used herein, the term “EPD-gO” is intended to refer to graphene oxide deposited from an electrophoretic method, unless specifically stated to the contrary. It is to be understood that chemical changes in the G-O occur as a result of the process of electrophoretic deposition. In one aspect, EPD-gO platelets have a different chemical composition in the electrophoretically deposited film than in the dispersion that they are deposited from.

As briefly described above, the present invention relates to graphene materials. In one aspect, the disclosure provides methods for the preparation of graphene based films. In another aspect, the disclosure provides methods for the preparation of large area graphene based films that can have uniform or substantially uniform thickness. In another aspect, the disclosure provides a method for the preparation of graphene based films utilizing electrophoretic deposition techniques. In still other aspects, the electrophoretic based techniques and resulting materials described herein can provide improved properties and performance as compared to graphene based films prepared from conventional techniques. In yet other methods, the disclosure provides a reduced graphene oxide film.

### Graphite Oxide Starting Material

The starting material for preparing a reduced graphene film can comprise a graphite oxide (GO), such as, for example, that synthesized from purified natural graphite. In one aspect, the purified natural graphite can be synthesized from the modified Hummers method. The graphite oxide can be dispersed in water and sonicated for a period of time sufficient to disperse at least a portion of the graphene oxide platelets therein. In a specific aspect, the graphite oxide can be sonicated for about 2 hours at room temperature to prepare a colloidal suspension of graphene oxide (G-O) platelets. It should be understood that, as used herein, a colloidal suspension is intended to describe a solution wherein a plurality of particles are at least partially suspended in a liquid. In one aspect, a colloidal suspension can comprise agglomerated and/or undispersed particles. In another aspect, at least a portion of the suspended graphene oxide platelets can agglomerate and/or settle after a period of time. In one aspect, the colloidal suspension is a stable or substantially stable suspension of graphene oxide platelets.

### Electrophoretic Deposition

The present disclosure utilizes an electric field to deposit graphene oxide platelets from a suspension onto a substrate. In one aspect, the methods described herein utilize electrophoretic techniques. In general terms, electrophoresis refers to the movement of particles in a fluid under an electric field.

In one aspect, electrophoretic deposition methods can provide advantages over conventional deposition methods in the preparation of thin films from, for example, charged colloidal suspensions. In various aspects, one or more of deposition rate, thickness control, film uniformity, and scale up, can be improved over conventional methods when using an electrophoretic deposition method.

A suspension of graphene oxide, such as, for example, a colloidal suspension of graphene oxide platelets can be electrophoretically deposited onto a substrate. In one aspect, a substrate can comprise a porous or networked material, capable of supporting a deposited film. In one aspect, the substrate is at least partially electrically conductive. In one aspect, the substrate can comprise a metal mesh. In another aspect, the substrate comprises a stainless steel mesh. The wire and/or opening size of a metal mesh can vary depending on, for example, the particular materials and process conditions employed, and the present invention is not intended to be limited to any particular mesh size. In one aspect, the substrate is about 200 mesh. In a specific aspect, the substrate is 200 mesh stainless steel. In other aspects, the substrate can comprise other electrically conductive materials and/or mixtures thereof. In one aspect, the substrate is not reactive with the graphene oxide that can be deposited thereon. In various aspects, the substrate can comprise copper, nickel, aluminum, stainless steel, p-type silicon, a conductive polymer, a carbon filled conductive polymer, or a combination thereof. In one aspect, the use of a stainless steel substrate can reduce and/or eliminate the formation of metal hydroxides at the electrode during deposition. In another aspect, all or a portion of the deposited graphene oxide platelets are reduced after being electrophoretically deposited.

The graphene coating materials of the present disclosure can also be used to provide a conductive coating onto an existing structure. For example, the surface of a structure intended to be painted using an electrostatic painting technique should be electrically conductive. In one aspect, a conductive or highly conductive graphene based coating can be applied to a structure to impart or improve the electrical conductivity thereof, and thus, facilitate the use of an electrostatic painting technique. While not intended to be limiting, such coating and painting techniques can be useful for large structures such as, for example, cars or airplanes.

In another aspect, a substrate can comprise a current collector suitable for use in an electronic device. In one aspect, the substrate can comprise a three dimensional structure, such as, for example, a comb-like structure, a honey-comb structure, or a combination thereof. In other aspects, one or more additional materials, such as a spacer material, can be layered in a deposited graphene film structure. For example, a thin film of graphene can be deposited on a substrate, onto which a spacer material can be positioned. Then, one or more additional graphene layers can be deposited so as to form a layered structure. In one aspect, such a structure can form a mesh, having enhanced surface area as compared to a thin film. In one aspect, after deposition and/or formation of a mesh structure, a spacer material can be removed from the structure. In other aspects, a spacer material can remain in a deposited structure. In such an aspect, the term “mesh” does not necessarily imply any orientation or arrangement of individual deposited platelets.

In still another aspect, graphene oxide platelets can be deposited simultaneously with or substantially simultaneously with one or more nanoparticles, wires, or a combination thereof. In such an aspect, the graphene film, when removed, can comprise a thin electrode material. In one aspect, such an embedded nanoparticle and/or wire can have a high lithium ion storage capacity. Exemplary nanoparticles and/or wires can comprise silicon, tin, lead, aluminum, or a combination thereof. In another aspect, such an electrode can be useful in, for example, a lithium ion cell.

The concentration of G-O in the suspension can be from about 0.5 mg/ml to about 10 mg/ml, for example, about 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.5, 5, 5.5, 6, 6.5, 7, 7.5, 8, 8.5, 9, 9.5, or 10 mg/ml. In other aspects, the concentration of G-O in the suspension can be less than about 0.5 mg/ml or greater than about 10 mg/ml, and the present invention is not intended to be limited to any particular concentration. In a specific aspect, the concentration of G-O is about 1.5 mg/ml. It should be understood that the concentration can vary depending upon the liquid and/or the electrophoretic deposition conditions. In various aspects, the deposition rate can be dependent on the concentration of G-O, the applied current and/or voltage, or a combination thereof.

In one aspect, the electric field is formed from application of a direct current voltage across two electrodes, one of which comprises the substrate, disposed in a colloidal suspension of graphene oxide platelets. The direct current voltage applied to the G-O can be from about 1 V to about 100 V, for example, about 1, 2, 3, 4, 5, 6, 7, 8, 9, 10, 12, 14, 16, 18, 20, 22, 24, 26, 28, 30, 35, 40, 45, 50, 55, 60, 6, 70, 75, 80, 85, 90, 95, or 100 V. In other aspects, the voltage can be less than about 1 V or greater than about 100 V, and the present invention is not intended to be limited to any particular voltage. In a specific aspect, the direct current voltage is about 10 V. It should be understood that the voltage can vary depending on the specific materials and process conditions used, and the present invention is not intended to be limited to any particular voltage building. In other aspects, the applied voltage can change during the course of a deposition, for example, as a stepped profile or a gradient. In another aspect, the voltage is held constant or substantially constant during the deposition. In another aspect, the voltage can be an alternating current (AC) voltage or a voltage having a rectangular waveform. In yet another aspect, the voltage can comprise other waveforms and/or can have a waveform that changes with respect to time. In one aspect, an alternating and/or rectangular waveform can render the substrate cathodic during at least a portion of the deposition process. The deposition time can range from about 5 seconds to about 10 minutes, for example, about 5 seconds, 10 seconds, 15 seconds, 20 seconds, 25 seconds, 30 seconds, 40 seconds, or 50 seconds, 1 minute, 2 minutes, 3 minutes, 4 minutes, 5 minutes, 6 minutes, 7 minutes, 8 minutes, 9 minutes, or 10 minutes. In other aspects, the deposition time can be less than about 5 seconds minute or greater than about 10 minutes. In one aspect, the deposition time is about 30 seconds or less. In another aspect, the deposition time is from about 15 seconds to about 2 minutes. The voltage and/or time of a deposition can be varied to control, for example, the thickness of the deposited film. In one aspect, films having a thickness of from about 100 nm to about 100 μm, for example, about 100, 200, 300, 400, 500, 600, 700, 800, 900, 1,000, 1,250, 1,500, 1,750, 2,000, 2,250, 2,500, 3,000, 4,000, 5,000, 7,500, 10,000, 12,000, 14,000, 16,000, 18,000, 20,000, 25,000, 30,000, 35,000, 40,000, 50,000, 60,000, 70,000, 80,000, 90,000, or 100,000 nm. In other aspects, the film thickness can be less than about 100 nm or greater than about 100 μm.

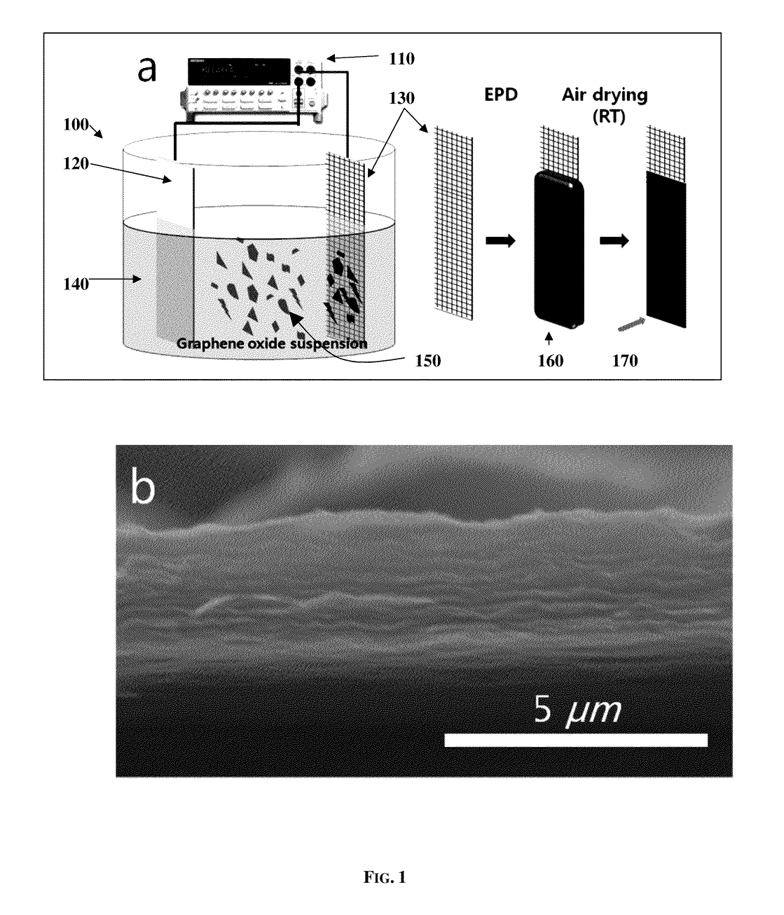

FIG. 1(a) is a schematic of an exemplary single compartment electrophoretic deposition experiment 100, wherein the leads of a voltage generator 110 are connected to electrodes 120 and 130, wherein one of the electrodes comprises a substrate 130, and wherein the electrodes are both disposed in a liquid 140 comprising a colloidal suspension of graphene oxide platelets 150. Once deposited, the substrate comprising the deposited graphene oxide platelets 160 can be dried and/or heat treated to form a reduced graphene oxide film 170. In such an aspect, at least a portion of the G-O platelets migrate towards the positive electrode under an applied electric field (e.g., when a direct current voltage is applied). The particular deposition rate achieved can depend upon factors such as, for example, the concentration of the G-O suspension, the applied voltage, and substrate conductivity. For example, deposition can be higher (e.g, about 5 fold) when deposited on a heavily p-type doped silicon substrate than on a comparable stainless steel substrate.

Once the direct current voltage is applied, deposition occurs on the anode. In one aspect, gas bubbles can also be generated at the cathode during deposition. In another aspect, one or more metal hydroxides can form on and/or at an electrode surface. In one aspect, when using a stainless steel substrate, the formation of such metal hydroxides can be reduced and/or eliminated.

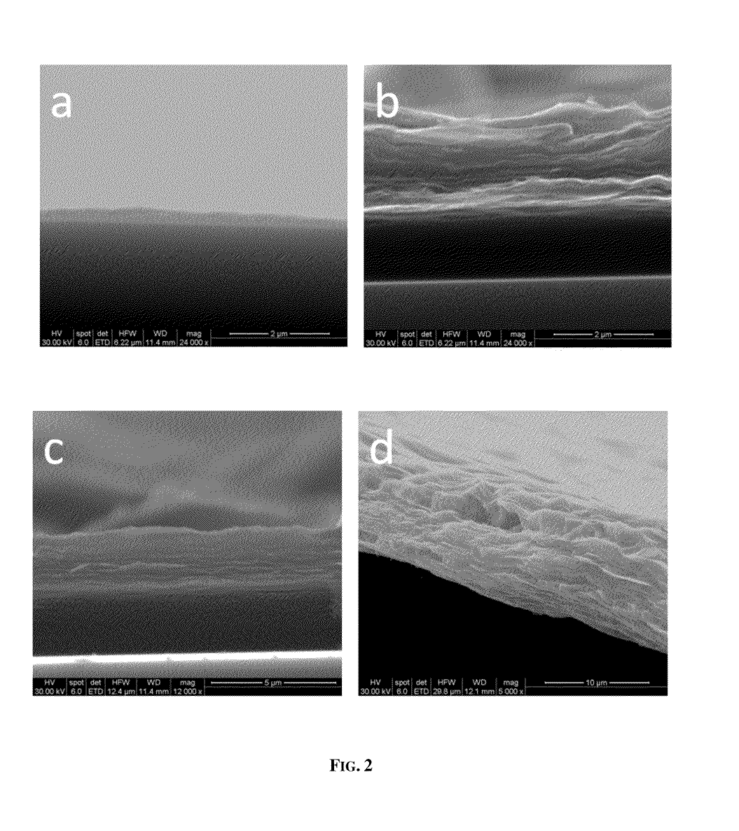

In an exemplary aspect, a 1.5 mg/ml suspension of G-O platelets can be used with a stainless steel substrate. When a 10 V potential is applied for about 30 seconds or less, a smooth film can be formed. After deposition, the deposited film can, in one aspect, be dried by exposing to ambient air for 24 hours and/or heating to effect drying. FIG. 1(b) illustrates a cross sectional scanning electron micrograph of an air dried, electrophoretically deposited G-O film having a 4 μm thickness (deposited over a 2 minute period). FIG. 2 illustrates cross sectional field emission scanning electron micrographs of electrophoretically deposited G-O films with varying deposition times: (a) 30 seconds, (b) 2 minutes, (c) 4 minutes, and (d) 10 minutes.

After air drying, the deposited film can, in one aspect, naturally delaminate from the substrate. In another aspect, the film can be physically removed from the underlying substrate. The resulting can then be cut, for example, with scissors, to expose edges as depicted herein. In one aspect, the thickness, uniformity, and packing morphology of the deposited and optionally dried film can be similar to G-O paper-like materials formed by filtration techniques.

### Properties of EPD-gO Films

In one aspect, a graphene film prepared from an electrophoretic method can have a lower or substantially lower oxygen content than films prepared from other techniques. For example, G-O has conventionally been reduced using hydrazine and/or strong alkaline solutions, such as, for example, (NaOH/KOH), or using high temperature treatment. To achieve high-yield and environmentally friendly methods, low temperature methods and/or methods free of harsh chemicals are desired. Thus, in one aspect, the present methods do not comprise the use of at least one of hydrazine, strong alkali solutions, or high temperature treatment. In another aspect, the present methods do not utilize hydrazine or strong alkali solutions.

In one aspect, the deposited graphene oxide platelets can be randomly oriented. In another aspect, the deposited graphene oxide platelets or at least a portion thereof can form an aligned sheet of graphene oxide platelets. Such an aligned sheet can, in one aspect, provide a high surface area for use as an electrode in an ultracapacitor, battery, or a combination thereof.

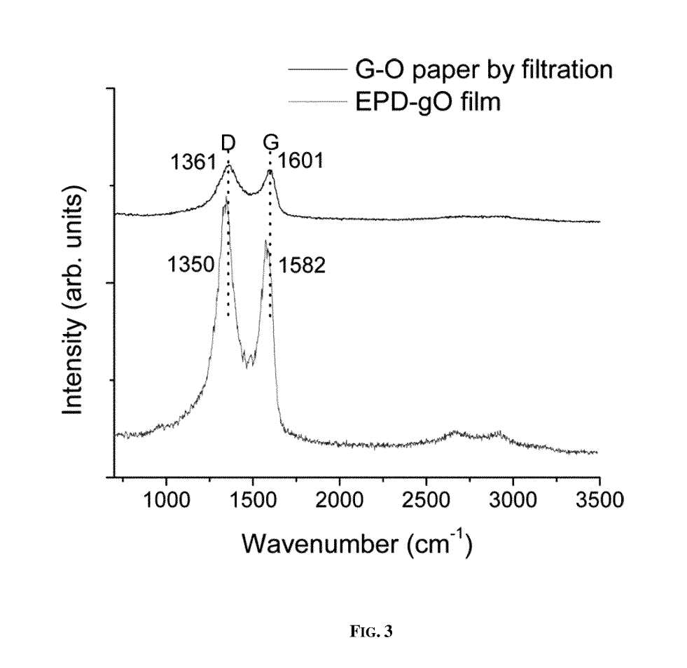

Raman spectroscopy can be used to analyze deposited EPD-gO films. As illustrated in FIG. 3, the Raman spectrum can exhibit a D-band around 1,350 cm⁻¹, a G-band about 1,582 cm⁻¹, and a broad 2D-band at about 2,800 cm⁻¹. The observed D-band can be due to defects and/or edges in the material. Each of the D, G, and/or 2D bands can be shifted to lower wave numbers for an electrophoretically deposited G-O film as compared to a conventionally prepared film using filtration techniques. For example, the G-band can occur at 1,601 cm⁻¹ for papers prepared by filtration, but at 1,582 cm⁻¹ for those prepared by electrophoretic deposition. While not wishing to be bound by theory, this shift can result from the reduction of G-O platelets comprising the film.

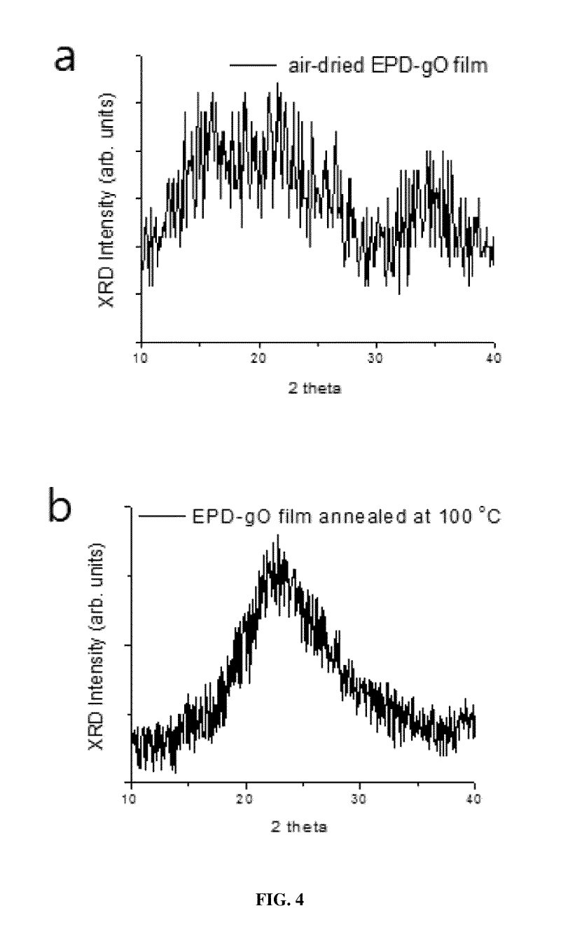

In addition, x-ray diffraction spectroscopy can be used to evaluate the interlayer spacing of overlapped and stacked platelets comprising an electrophoretically deposited film. In one aspect, an air dried EPD-gO film can exhibit a broad diffraction peak at a 2θ of 18°, suggesting an interlayer spacing of about 5.1 Å. This interlayer spacing is, in various aspects, larger than that of graphite and smaller than that of traditional G-O paper (8.0-8.3 Å). In one aspect, as illustrated in FIG. 4, the mean d-spacing was 0.51 nm for an air dried EPD-gO film and 0.37 nm for heat treated EPD-gO films.

The deposited film can also be annealed, for example, at about 100° C. In one aspect, a deposited sample is annealed. In another aspect, a deposited sample is not annealed prior to use. In one aspect, the XRD spectrum of an annealed EPD-gO film sample indicated a d002 spacing slightly larger than graphite. While not wishing to be bound by theory, the interlayer spacing can be the result of water molecules being trapped between the hydrophilic G-O platelets.

The electrical conductivity of an electrophoretically deposited G-O film, such as, for example, an air dried EPD-gO film, can be from about 1×10² S/m to about 30×10² S/m, for example, about 1, 2, 3, 4, 5, 6, 7, 8, 9, 10, 12, 14, 16, 18, 20, 22, 24, 26, 28, or 30×10² S/m, as measured by the van der Pauw method. In other aspects the electrical conductivity of an electrophoretically deposited G-O film can be less than about 1×10² S/m or greater than about 30×10² S/m, and the present invention is not intended to be limited to any particular electrical conductivity.

In one aspect, the electrical conductivity values obtainable on EPD-gO films can be higher and/or substantially higher than for comparable G-O films prepared by filtration methods. After annealing in air at 100° C. for 1 hour, an air dried EPD-gO sample can exhibit an electrical conductivity of at least about 0.2×10⁴ S/m, at least about 0.5×10⁴ S/m, at least about 1×10⁴ S/m, at least about 2×10⁴ S/m, at least about 3×10⁴ S/m, at least about 4×10⁴ S/m, at least about 5×10⁴ S/m, at least about 6×10⁴ S/m, at least about 7×10⁴ S/m, at least about 8×10⁴ S/m, at least about 9×10⁴ S/m, or more. In a specific aspect, an air dried EPD-gO sample can exhibit an electrical conductivity, after annealing, of about 1.43×10⁴ S/m. In another aspect, the graphene film prepared from the methods described herein can comprise a conductive, low-contact resistance coating.

In addition, elemental analysis of EPD-gO samples suggest an increase in the ratio of carbon to oxygen for air dried EPD-gO films (6.2:1), as compared to G-O films prepared by filtration (1.2:1). For annealed samples, the C/O atomic ratio can be about 9.3:1. When comparing films prepared from various techniques, the EPD-gO prepared material has a significantly higher oxygen atom concentration than a comparable chemically reduced exfoliated graphene oxide, but less than a G-O film obtained by a simple filtration method. Thus, deoxygenation can occur during the electrophoretic deposition process. Graphite oxide produced by the Hummers method can have oxygen functional groups, such as, hydroxyl and epoxide groups, disposed on basal plane surfaces and carbonyl functional groups disposed on edge plane surfaces. In one aspect, at least a portion of the oxygen functional groups can be removed in an electrophoretic deposition process, wherein negatively charged G-O platelets are electrophoretically drawn to the positive electrodes.

Once the platelets contact the anode, electrons can move away from the platelets, resulting in oxidation of any carboxylate groups present. The unpaired electrons formed by the loss of CO₂ can then be free to migrate through the G-O framework, to find other unpaired electrons and form covalent bonds. The reaction of radicals to form two-electron bonds can occur substantially within the graphene oxide platelets; however, the formation of bonds between platelets that are close enough and favorably oriented can also occur.

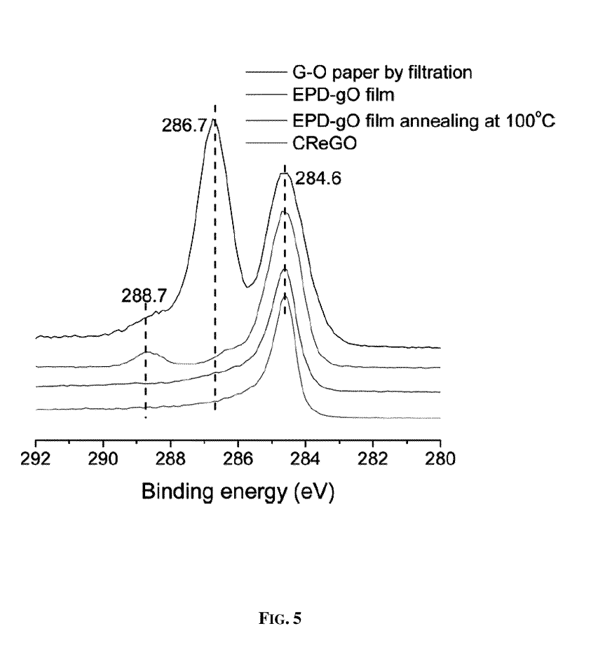

X-ray photoelectron spectroscopy (XPS) can also be used to evaluate the surface layers of EPD-gO films. As shown in FIG. 5, the C1s spectrum of G-O paper obtained by filtration exhibits two dominant peaks centered at 284.6 eV and 286.7 eV, with a weak peak at 288.7 eV. The C1s peak at 284.6 eV is associated with the binding energy of sp2 C—C bonds. The peak at 286.7 eV corresponds to C—O bonds in epoxy/ether groups. Additionally, the peak around 288.7 eV can be assigned to C═O bonds in ketone/carboxylic groups. In comparison to the C1s spectrum of the G-O paper obtained by the filtration method, that of the EPD-gO film exhibited suppression of the epoxy/ether groups (286.7 eV) peak with a remaining small peak at 288.7 eV. After annealing at 100° C. in air, the oxygen-containing functional group peaks virtually disappear, and the peak shape becomes similar to that of CReGO obtained by reduction of G-O with hydrazine.

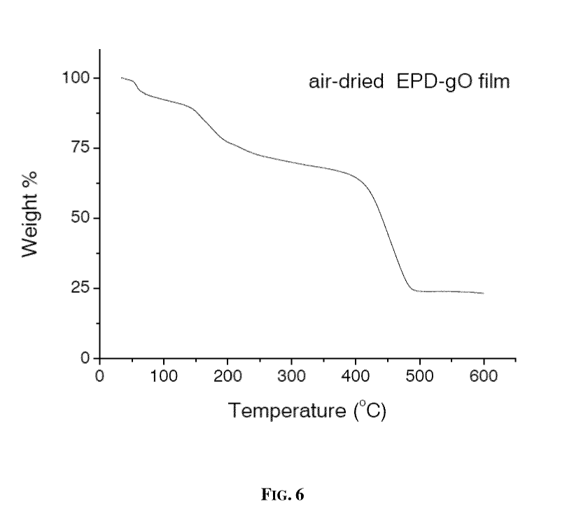

Thermal gravimetric analysis (TGA) can also be used to evaluate EPD-gO films. An exemplary EPD-gO film exhibited a weight loss of about 8 wt % around 100° C. While not wishing to be bound by theory, the weight loss likely occurs due to evaporation of water molecules contained in the material. Such removal of water by heating at 100° C. is supported by the XRD data described herein. As illustrated in FIG. 6, the initial weight loss region from room temperature to about 100° C. can be attributed to the removal of physisorbed water.

Deoxidation of GO and G-O typically does not occur until at temperatures less than about 200° C. Above this temperature, deoxidation is a kinetic process, wherein exposure time is significant and reduction can occur at lower temperatures due to evolution of carbon monoxide/carbon dioxide. Thus, in one aspect, EPD-gO platelets can have a C:O ratio of from about 7.9:1 to about 10.1:1, for example, about 7.9:1, 8:1, 8.2:1, 8.4:1, 8.6:1, 8.8:1, 9:1, 9.2:1, 9.4:1, 9.6:1, 9.8:1, 10:1, or 10.1:1. In other aspects, EPD-gO platelets can have a C:O ratio of less than about 7.9:1 or greater than about 10.1:1. In a specific aspect, the EPD-gO platelets have a C:O ratio of about 9:1, with any remaining water originating from interlamellar water (that can be removed by heating at 100° C.).

In various aspects, the resulting film can comprise a paper. In various aspects, the prepared film can be utilized as a paper material, similar to conductive papers utilized in electronic devices. In another aspect, a large area paper can be produced using the methods described herein. In one aspect, such a paper can have at least one large lateral dimension. In still other aspects, a film or paper produced from the methods described herein can be electrically conductive or substantially electrically conductive.

In another aspect, the resulting film is flexible. Such a flexible film can be useful in a variety of applications, such as, for example, flexible ultracapacitors.

Thus, the methods described herein can provide electrophoretically deposited films having overlapped and stacked platelets of reduced G-O. In addition, the electrophoretically deposited film can have a significantly reduced concentration of oxygen functional groups and improved electrical conductivity as compared to G-O papers prepared by filtration methods.

In one aspect, the methods of the present invention can be used to prepare films of graphene materials faster than with conventional techniques. In another aspect, the methods of the present invention can be used to prepare films of graphene materials faster than with conventional techniques.

Also, there is essentially no adhesion after the as-deposited film dries. Thus, this method for reducing G-O without harsh and toxic chemicals, and at room temperature, has the potential for rapid, high-yield, large-area, low-cost, and environmentally friendly production of films composed of paper-like samples that are easily removed from a substrate.

In another aspect, one or more spacer materials can be used to form, for example, a capacitor. In such aspects, a spacer material can comprise activated carbon, carbon nanotubes, nanoparticles, silica, other spacer materials known in the art, and combinations thereof.

Films of reduced graphene oxide, as described herein can be used to prepare an electrode, wherein a uniform or substantially uniform graphene coating is applied to a surface of a current collector and/or a conducting substrate. In one aspect, an electrode comprising a graphene film, as prepared herein, can be used in a flexible ultracapacitor. In another aspect, the graphene film can be used in an electrode assembly comprising an electrically conductive graphene material. Such an assembly can, in one aspect, be prepared by coating a thin, uniform, electrically conductive graphene onto at least a portion of a conductive substrate. In another aspect, such an assembly can have a low equivalent series resistance for a high power density ultracapacitor.

In another aspect, the present invention can comprise a composition suitable for use as a pseudocapacitor electrode, comprising a carbon matrix and a pseudocapacitive material positioned on a current collector and/or a conductive substrate. In such an aspect, an exemplary carbon matrix can comprise a reduced graphene oxide as prepared herein. In another aspect, a pseudocapacitive material can comprise a metal oxide, such as, for example, MnO₂, SiO₂, RuO₂, MoO₂, NiO, or a combination thereof.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### Preparation of Graphite Oxide

In a first example, a graphite oxide sample was prepared using a modified Hummer's method. 500 mg of natural graphite (SP-1, available from Bay Carbon) was mixed with 20 ml of concentrated H₂SO₄ in a flask, followed by the addition of 1.75 g of KMnO₄ over a 15 minute period; during addition of KMnO₄ the mixture was stirred with a Teflon-coated stirring bar while positioned in a water bath at room temperature. After addition of KMnO₄, the mixture was heated at 35° C. and stirred for 2 hours. An ice bath was then used to cool down the solution to about 3-4° C., after which 23 ml of deionized water was slowly added into the flask while stifling to minimize heating. The temperature in the ice bath was monitored and controlled to be no higher than 7° C. by adding ice and controlling the addition of deionized water. Once the temperature was stabilized, more deionized water (270 ml) was added to further dilute the suspension. The suspension was continuously stirred at 300 rpm. H₂O₂ solution was added drop-wise to remove excess KMnO₄. The final suspension was filtered and washed with HCl (10% in water), and then dried in air. Further drying was done in vacuum at room temperature for one day.

### Example 2

### Electrophoretic Deposition

In a second example, graphene oxide (G-O) was deposited using electrophoretic deposition techniques. For the electrophoretic deposition (EPD), the graphite oxide (GO) was first dispersed in water and sonicated (VWR B2500A-MT) for 2 h at room temperature. A uniform and stable suspension in water containing 1.5 mg/mL of graphene oxide (G-O) platelets was obtained.

A 200 mesh stainless steel substrate (3×5 cm) was then used as a positive electrode (anode). Other materials, such as, for example, aluminum foil, copper plate, nickel plate, and Si wafer substrates have also been used as anode materials. The electrodes were vertically oriented and separated by 1 cm in a beaker containing the G-O suspension. A direct-current voltage was then applied in the range of 1-40 V (Keithley 6613C DC power supply), with deposition times ranging from 1 to 10 min. After deposition, samples were air-dried at room temperature for 24 h.

### Example 3

### Characterization of Films

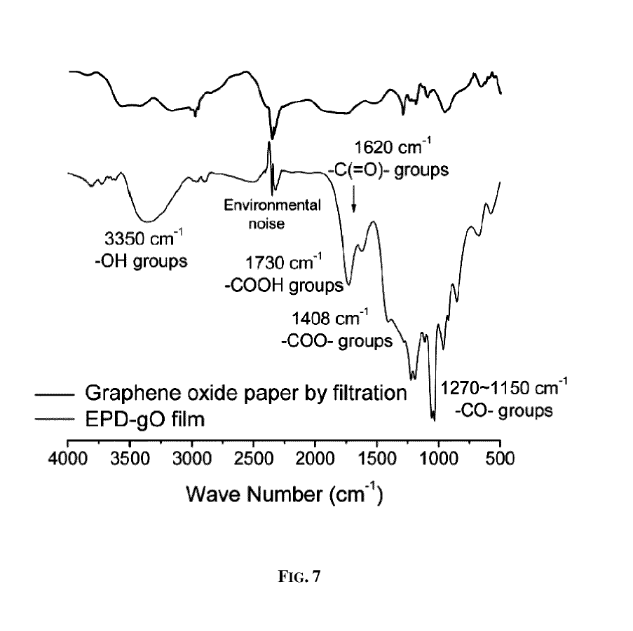

In a third example, electrophoretically deposited films were characterized. Raman measurements were made using a WiTec Alpha300 confocal Raman microscope with a 532 nm line from a frequency-doubled Nd:Yag laser. The electrical conductivity of the deposited films was measured by the van der Pauw method (using a Keithley 6221 DC and AC current source, and two electrometers, both Keithley 6514). Elemental analysis was also performed on the resulting ‘G-O paper’ and ‘EPD-gO film’ samples. A FEI Quanta-600 FEG Environmental SEM was used to obtain the cross-sectional image of the EPD-gO film. The thermogravimetric analysis (TGA) of paper samples was measured with a PERKIN-ELMER TGA with a heating rate of 1° C./min in nitrogen. XRD of the EPD-gO film was measured from 5° to 50° (two theta) in part to obtain the mean interlayer spacing of the stacked and overlapped platelets (Phillips APD 3520 powder X-ray diffractometer with Cu K-alpha radiation (40 keV, 30 mA) with a step increment 0.02 degrees (two theta) and a dwell time of 1.0 second). Samples approximately 3-mm by 3-mm were sectioned and mounted using a low melting temperature wax onto a special Quartz substrate (cut 6° from (0001)) designed to minimize background signal. Fourier transformed infrared (FT-IR) spectra were measured by a Thermo Mattson Infinity Gold FTIR, the resulting spectra illustrated in FIG. 7.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for depositing a graphene material on a substrate, the method comprising
a. providing a suspension of graphene oxide platelets and a substrate, and then
b. applying an electric field across at least a portion of the suspension so as to deposit at least a portion of the graphene oxide platelets on the substrate.

2. The method of claim 1, wherein application of the electric field comprises an electrophoretic technique.

3. The method of claim 1, comprising a cathode disposed in the suspension, and wherein the substrate is an anode.

4. The method of claim 3, wherein the electric field is the result of a direct current voltage applied between the anode and the cathode.

5. The method of claim 4, wherein the voltage is about 10 V.

6. The method of claim 1, wherein the suspension is a colloidal suspension of graphene oxide platelets and has a concentration of graphene oxide platelets of from about 0.5 to about 10 mg/ml.

7. The method of claim 1, wherein the suspension has a concentration of graphene oxide platelets of about 1.5 mg/ml.

8. The method of claim 1, wherein the electric field is applied for a period of time of from about 5 seconds to about 10 minutes.

9. The method of claim 1, wherein a graphite oxide is disposed in a liquid and sonicated to produce the graphene oxide platelets.

10. The method of claim 1, wherein the substrate is an at least partially electrically conductive mesh, plate, foil, prefabricated structure, or a combination thereof.

11. The method of claim 1, wherein the substrate comprises stainless steel, aluminum, copper, nickel, p-type doped silicon, carbon filled conductive polymer, or a combination thereof.

12. The method of claim 1, wherein the deposited graphene oxide platelets form a film on at least a portion of the substrate.

13. The method of claim 12, wherein the film has a thickness of from about 100 nm to about 100 μm.

14. The method of claim 12, wherein the film has a uniform or substantially uniform thickness.

15. The method of claim 12, wherein the film forms a paper.

16. The method of claim 15, wherein the paper is flexible.

17. The method of claim 12, wherein the film has an electrical conductivity of at least about 1×10⁴ S/m.

18. The method of claim 1, further comprising drying the deposited graphene oxide platelets.

19. The method of claim 18, wherein after drying, at least a portion of the graphene oxide platelets are reduced.

20. The method of claim 1, wherein the electric field is formed from at least one of an alternating current voltage, a rectangular waveform, or a combination thereof.

21. The method of claim 20, wherein the electric field is applied such that the substrate is cathodic during at least a portion of the deposition.

22. The method of claim 1, wherein at least a portion of the graphene oxide platelets are simultaneously reduced when deposited on the substrate.

23. The method of claim 1, further comprising positioning a spacer in contact with at least a portion of the deposited graphene oxide platelets.

24. The method of claim 23, wherein after deposition, the substrate comprises a plurality of layers, wherein each layer comprises graphene oxide platelets, a spacer, or a combination thereof.

25. The method of claim 23, wherein the spacer comprises activated carbon, carbon nanotubes, nanoparticles, silica, or a combination thereof.

26. The method of claim 1, wherein a plurality of graphene oxide platelets are deposited while simultaneously embedding one or more spacer materials therein.

27. The method of claim 26, further comprising removing at least a portion of the embedded spacer material after depositing.

28. The method of claim 1, wherein the substrate comprises a current collector having a comb-like structure, a honey-comb like structure, or a combination thereof.

29. The method of claim 28, wherein the deposited graphene oxide platelets comprise one or more aligned graphene sheets.

30. The method of claim 1, wherein the deposited graphene oxide comprises a conductive, low contact resistance thin film coating.

31. The method of claim 1, wherein a plurality of nanoparticles, wires, or a combination thereof are positioned so as to be embedded in the deposited graphene oxide.

32. The method of claim 31, wherein at least a portion of the plurality of nanoparticles, wires, or a combination thereof have a high lithium ion storage capacity.

33. The method of claim 31, wherein the plurality of nanoparticles, wires, or a combination thereof comprise silicon, tin, lead, aluminum, or a combination thereof.

34. The method of claim 31, wherein the deposited graphene oxide comprises the embedded nanoparticles, wires, or a combination thereof, and is suitable for use as an anode in a lithium ion cell.

35. The product of the method of claim 1.

36. An electrode comprising the product of the method of claim 1.

37. A composition comprising a matrix of electrically conductive reduced graphene oxide and a plurality of nanoparticles, wires, or a combination thereof embedded therein.

38. An electronic device comprising the product of the method of claim 1.

39. The electronic device of claim 38, wherein the device is a flexible ultracapacitor.
